(19) United States
(12) Patent Application Publication
(10) Pub. No.: US 2011/0144804 A1
(43) Pub. Date: Jun. 16, 2011

(54) DEVICE AND METHOD FOR EXPRESSING ROBOT AUTONOMOUS EMOTIONS

(75) Inventors: Kai-Tai SONG, Hsinchu City (TW); Meng-Ju Han, Sanxia Township (TW); Chia-How Lin, Guangfu Township (TW)

(73) Assignee: NATIONAL CHIAO TUNG UNIVERSITY of Taiwan, Republic of China

(21) Appl. No.: 12/779,304

(22) Filed: May 13, 2010

(30) Foreign Application Priority Data
Dec. 16, 2009 (TW) 098143100

(51) Int. Cl. B25J 9/16; G06N 5/02; G06F 15/18; G06N 3/06; G06N 7/04

(52) U.S. Cl. 700/246; 706/2; 706/12; 706/47; 901/50

(57) ABSTRACT

A device for expressing robot autonomous emotions comprises: a sensing unit; a user emotion recognition unit, recognizing current user emotional states after receiving sensed information from the sensing unit, and calculating user emotional strengths based on the current user emotional states; a robot emotion generation unit, generating robot emotional states based on the user emotional strengths; a behavior fusion unit, calculating a plurality of output behavior weights by a fuzzy-neuro network based on the user emotional strengths and a rule table; and a robot reaction unit, expressing a robot emotional behavior based on the output behavior weights and the robot emotional states.

### BACKGROUND OF THE INVENITON

1. Field of the Invention

The present invention is related to a device and a method for expressing robot autonomous emotions, particularly, to a device and a method for making a robot have different human-like characters (for example, optimism, pessimism, etc.), based on information sensed by ambient sensors and settings for required anthropomorphic personality characteristics.

2. Description of the Related Art

A conventionally-designed robot is interacted with human in one-to-one mode. That is, a corresponding interactive behavior of the robot is determined by the input information of a single sensor without anthropomorphic personality characteristics of the robot itself, influences of variations inhuman emotional strengths, and outputs having the fusion of emotional variations, etc., so that the presentation of the robot becomes a mere formality and is not natural enough during the interactive process.

The prior art, such as Taiwan Patent No. 1311067, published on 21 Jun. 2009, (hereinafter, referred to as patent document 1) discloses a method and an apparatus of interactive gaming with emotion perception ability, wherein a user emotional state is judged on understanding the user's real-time physiological signal and motion condition, and then, the user emotional state is fed back to a game platform so as to generate a user interactive entertainment effect. However, the technology disclosed in patent document 1 is to convert each input emotional signal into a corresponding output entertainment effect directly without outputs merged with an emotional variation effect. Therefore, it does not include variations in anthropomorphic personality characteristics and human-like complex emotional outputs.

Taiwan Patent No. 1301575, published on 1 Oct. 2008, (hereinafter, referred to as patent document 2) discloses an inspiration model device, a spontaneous emotion model device, an inspiration simulation method, a spontaneous emotion simulation method and a computer-readable medium with program recorded. Patent document 2 searches knowledge data from a knowledge database by approaching human's perception behavior and are previously modeled human's emotions as data, thereby simulating human's inspiration sources that are susceptible to sensation. However, patent document 2 achieves a response to human by an emotion model database, and does not take the influence of a user emotional strength into consideration, and thus causes difficult changes in different anthropomorphic personality characteristics, due to complexity in establishing the database.

Furthermore, U.S. Pat. No. 7,515,992 B2, published on 7 Apr. 2009, (hereinafter, referred to as patent document 3) discloses a robot apparatus and an emotion representing method therefor, wherein after a camera and a microphone sense information, a robot emotional state is calculated by using this information, and then, various basic postures in a mobile database are looked up, so as to achieve the purpose of emotion expression. However, a robot emotional state established in patent document 3 does not take variations in user emotional strengths into consideration and lacks human's character expression, therefore lowering the interest and nature of human-robot interaction.

Additionally, U.S. Pat. No. 7,065,490 B1, published on 20 Jun. 2006, proposes that a camera, a microphone, and a touch sensor are used to obtain environmental information, and dog-type robot emotional states are established by the information. Under different emotional states, the dog-type robot will make different sounds and motions to exhibit an entertainment effect. However, the dog-type robot emotional states established by this invention do not have the fusion of emotional behaviors to be outputs, and can not exhibit complex emotion variations of dog-like characters.

In non-patent documents, T. Hashimoto, S. Hiramatsu, T. Tsuji and H. Kobayashi, “Development of the Face Robot SAYA for Rich Facial Expressions,” in Proc. Of International Joint Conference on SICE-ICASE, Busan, Korea, 2006, pp. 5423-5428, disclose a human-simulating robotic face, which achieves variations in human-like expressions by 6 kinds of facial expressions and sound-producing ways. However, this robotic face does not take user emotional strengths into consideration, the 6 kinds of facial expressions are set by changing several sets of fixed control point distance, and does not consider the emotional variation fusion outputs of the robot itself, so that it does not have variations in human-like subtle expressions. Further, D. W. Lee, T. G. Lee, B. So, M. Choi, E. C. Shin, K. W. Yang, M. H. Back, H. S. Kim, and

H. G. Lee, “Development of an Android for Emotional Expression and Human Interaction,” in Proc. Of World Congress of International Federation of Automatic Control, Seoul, Korea, 2008, pp. 4336-4337, disclose a singing robot having a robotic face, which can capture images and sounds, and achieve the interaction with human by synchronous progress of expression variations, sounds, and lip. However, this document does not disclose that the robot can determines the emotional states of the robot itself, based on user emotional strengths, but the robot just shows variations in human-simulating expresses on its robotic face.

In view of the disadvantages of the above-mentioned prior technologies, the present invention provides a robot autonomous emotion generation technology, by which a robot can establish autonomous emotional states, based on variations inhuman emotional strengths and the fusion outputs of emotional variations in cooperation with required anthropomorphic personality characteristics and the sensed information of ambient sensors.

### SUMMARY OF THE INVENTION

An objective of the present invention is to provide a robot autonomous emotion generation technology, by which a robot can establish autonomous emotional states, based on the information of ambient sensors, so as to have human-like emotions and characters (for example, optimism or pessimism, etc.), and meanwhile, the robot is merged with the effect of emotional variations so as to output human-like complex emotional expression and more natural and decent in human-robot interaction.

Another objective of the present invention is to provide a device for expressing robot autonomous emotions, comprises: a sensing unit; a user emotion recognition unit, recognizing current user emotional states after receiving sensed information from the sensing unit and calculating user emotional strengths based on the current user emotional states; a robot emotion generation unit, generating robot emotional states based on the user emotional strengths; a behavior fusion unit, calculating a plurality of weights of output behaviors by a fuzzy-neuro network based on the user emotional strengths and a rule table; and a robot reaction unit, expressing a robot emotional behavior based on the weights of the output behaviors and the robot emotional states.

A further objective of the present invention is to provide a method for expressing robot autonomous emotions, comprising: obtaining sensed information by a sensor; recognizing current user emotional states based on the sensed information and calculating user emotional strengths based on the current user emotional states by an emotion recognition unit; generating robot emotional states based on the user emotional strengths; calculating a plurality of weights of output behavior by a fuzzy-neuro network based on the user emotional strengths and a rule table; and expressing a robot emotional behavior based on the weights and the robot emotional states.

As above-described device and method, the fuzzy-neuro network is an unsupervised learning neuro-network.

As above-described device and method, the fuzzy-neuro network is a fuzzy Kohonen clustering network (FKCN) having an at least three-layer structure and a full connection in the linkers between different layers of neurons.

AS above-described device and method, the fuzzy-neuro network comprise: an input layer, to which pattern to be identified are inputted; a distance layer, calculating the difference grades between the inputted patterns and typical patterns; and a membership layer, calculating the membership grades of the inputted patterns with respect to the typical patterns, wherein the membership grades are values between 0 and 1.

AS above-described device and method, the sensed information comprises information obtained by at least one of a camera, a microphone, an ultrasonic device, a laser scanner, a touch sensor, a complementary metal oxide semiconductor (CMOS) image sensor, a temperature sensor and a pressure sensor, or their combination in part.

AS above-described device and method, the rule table contains at lease one set of user emotional strength weights and at least one set of robot behavior weights corresponding to the user emotional strength weights.

AS above-described device and method, the robot reaction unit comprises a robotic face expression simulator for expressing a robot emotional behavior.

AS above-described device and method, the robot reaction unit comprises an output graphical human-like face, wherein the output graphical human-like face can express human face-like emotions.

As above-described device and method, the output graphical human-like face can be applicable to any one of a toy, a personal digital assistant (PDA), an intelligent mobile phone, a computer and a robotic device.

The present invention has the following technical features and effects:

1. The character of the robot can be set according to the personality characteristic of a user so as to make the robot possess different human-like characters (for example, optimism or pessimism, etc.), and simultaneously, have complex expression behavior outputs (for example, any one of happiness, anger, surprise, sadness, boredom, and neutral expressions or their combination) so that emotional connotations and interests are added in human-robot interaction.
2. The problem that a conventionally-designed robot interacts with human in one-to-one mode, is resolved, i.e., the problem in the prior art that a corresponding interactive behavior is determined on the input information of a single sensor, is resolved, so as to prevent the human-robot interaction from becoming a formality or being not natural enough. Moreover, the reaction of the robot of the present invention can make a fusion judgment with the information outputted from the sensor, so that the interactive behavior of the robot can have different levels of variations, making the human-robot interactive effect more decent.
3. The present invention establishes the personality characteristic of the robot by using and adjusting the parameter weights of the fuzzy-neuro network.
4. The present invention uses an unsupervised learning fuzzy Kohonen clustering network (FKCN) to calculate the weights required for the robot behavior fusion. Therefore, the robot character of the present invention can be customized by a rule instituted by the user.

To make the above and other objectives, features and advantages of the present invention more apparent, the detailed descriptions is given hereinafter with reference to exemplary preferred embodiments in cooperation with accompanying drawings.

### BRIEF DESCRIPTION OF THE DRAWINGS

FIG. 1 is a structure diagram of a device for expressing robot autonomous emotions according to the present invention.

FIG. 2 is a structure diagram according to an exemplary embodiment of the present invention.

FIG. 3 is an exemplary structure diagram of a fuzzy Kohonen clustering network (FKCN) used in the present invention.

FIG. 4 is a simulation picture of a robotic face expression simulator in a robot reaction unit according to an exemplary embodiment of the present invention.

FIG. 5 shows control points on a robotic face in the robot reaction unit of the present invention.

FIG. 6(a)-6(i) shows the variation of robotic face expression in the robot reaction unit of the present invention under different happiness and sadness output behavior weights, wherein FIG. 6(a) shows a behavior weight with 20% of happiness; FIG. 6(b) shows a behavior weight with 60% of happiness; FIG. 6(c) shows a behavior weight with 100% of happiness; FIG. 6(d) shows a behavior weight with 20% of sadness; FIG. 6(e) shows a behavior weight with 60% of sadness; FIG. 6(f) shows a behavior weight with 100% of sadness; FIG. 6(g) shows a behavior weight with 20% of surprise; FIG. 6(h) shows a behavior weight with 60% of surprise; and FIG. 6(i) shows a behavior weight with 100% of surprise.

FIG. 7 shows the variation of robotic face expression in the robot reaction unit of the present invention under different happy and sad emotion strengths, wherein FIG. 7 (a) shows 20% of happiness and 80% of anger in strength; FIG. 7(b) shows 40% of happiness and 60% of anger in strength; FIG. 7(c) shows 60% of happiness and 40% of anger in strength; and FIG. 7(d) shows 80% of happiness and 20% of anger in strength.

### DESCRIPTION OF THE PREFERRED EMBODIMENTS

The application of the present invention is not limited to the following description, drawings or details, such as exemplarily-described structures and arrangements. The present invention further has other embodiments and can be performed or carried out in various different ways. In addition, the phrases and terms used in the present invention are merely used for describing the objectives of the present invention, and should not be considered as limitations to the present invention.

In the following embodiments, assume that two different characters (optimism and pessimism) are realized on a computer-simulated robot, and assume that a user has four different levels of emotional variations (neutral, happiness, sadness and anger) while a robot is designed to have four kinds of expression behavior outputs (boredom, happiness, sadness and surprise). Through a computer simulation, an emotional reaction method of the present invention can calculate the weights of four different expression behavior outputs, and reflect human-like robotic face expressions by the fusion of the four expression behaviors.

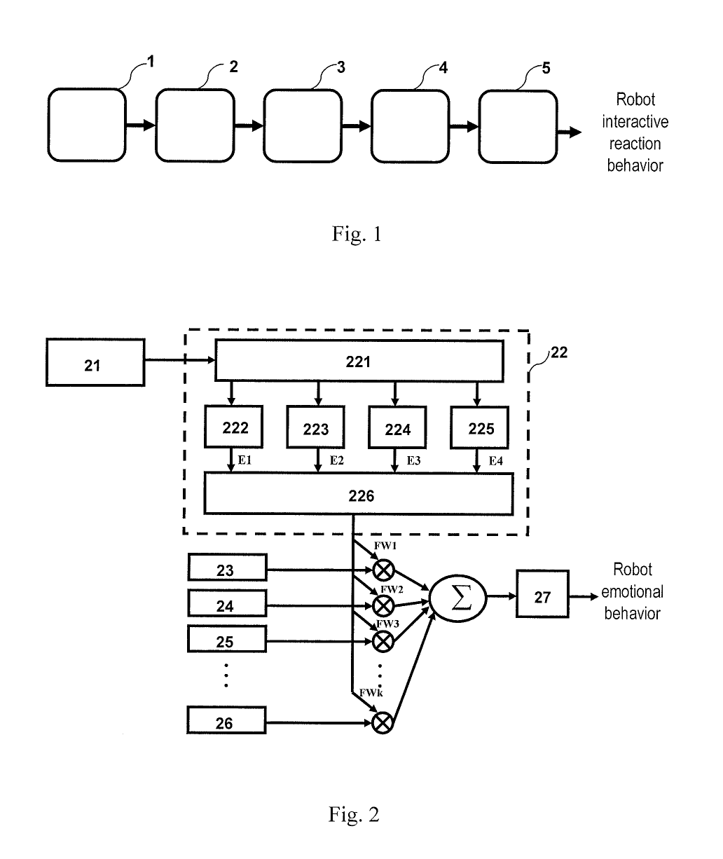

Referring to FIG. 1, a structure diagram of a device for expressing robot autonomous emotions according to the present invention is shown, wherein the device for expressing robot autonomous emotions mainly comprises: a sensing unit 1, obtaining some sensed information; a user emotion recognition unit 2, recognizing a current emotional state of a user based on the sensed information; a robot emotion generation unit 3, calculating a corresponding emotional state of a robot based on the current emotional state of the user; a behavior fusion unit 4, calculating different behavior weights based on the emotional components of the robot itself ; and a robot reaction unit 5, expressing different emotional behaviors of the robot.

In order to further describe the above technology of the present invention, the description is given with reference to a structure diagram of FIG. 2 according to an exemplary embodiment. However, the present invention is not limited to this.

Referring to FIG. 2, when an emotional state recognizer 22 obtains the image of a user from a CMOS image sensor 21 (for example, a camera), the image is recognized by an image recognizer 221, and thereafter, calculates user emotional strengths (in this example, four emotional strengths E₁˜5₄) and are sent to a fuzzy-neuro network 226 in a behavior fusion unit to calculate corresponding different output behavior weights (FWᵢ, i=1˜k). Then, each output behavior of the robot is multiplied by a corresponding weight, so that a robot reaction unit 27 can express various emotional behaviors of the robot.

During above behavior fusion process, a fuzzy Kohonen clustering network (FKCN) of the fuzzy-neuro network is used to calculate the weights required for the robot behavior fusion, wherein the FKCN is an unsupervised learning neuro-network.

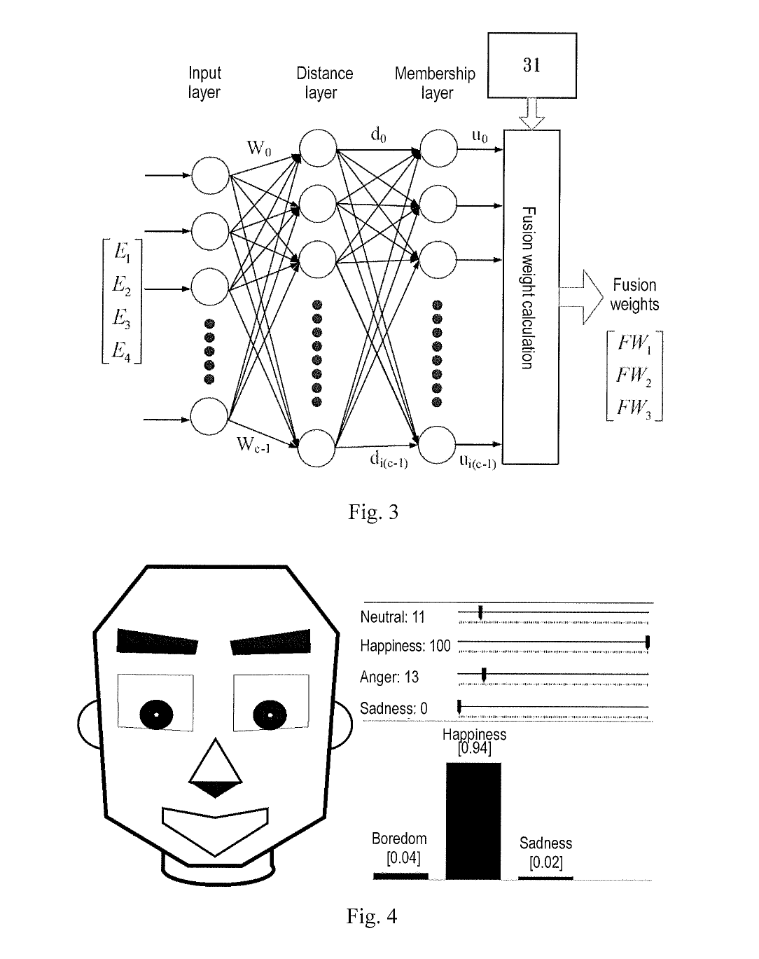

Referring to FIG. 3, an exemplary structure diagram of the fuzzy Kohonen clustering network (FKCN) is shown, wherein the linkers between different layers of neurons are fully connected. The FKCN contains three layers, wherein a first layer is an input layer for receiving input patterns (E₁˜Eᵢ) to be recognized; a second layer is a distance layer for calculating the distances between the input patterns and typical patter (W₀˜W_{c-1}), i .e . , calculating difference grades (d₀˜dᵢ(_{c-1}); a third layer is a membership layer, for calculating the membership grades uᵢⱼ of the inputted patterns with respect to the typical patterns, wherein the membership grades are shown as values between 0 and 1. Therefore, weights FW₁˜FW₃ required for the robot behavior fusion can be calculated by the obtained membership grades and a rule table 1 for determining the character of the robot itself.

Next, referring to FIG. 4, a simulation picture of a robotic face expression simulator in the robot reaction unit according to an exemplary embodiment is shown, wherein the left side shows a robotic face, the upper-right side shows four emotional strengths obtained by recognizing a user expression using an emotional state recognition unit, the lower-right side shows three output behavior fusion weights calculated by a behavior fusion unit. In the exemplary embodiment, as shown in FIG. 5, the robotic face is set to have 18 control points, which control the up, down, left and right movements of the left and right eyebrows (4 control points), the left and right up/down eyelids (8 control points), the left and right eyeballs (2 control points) and the mouth (4 control points), respectively. Therefore, the robotic face can exhibit different output behaviors by controlling these control points. However, the present invention does not limit to this, i.e., the subtlety of the robotic expression varies with the number of control points set on the robotic face and their control positions.

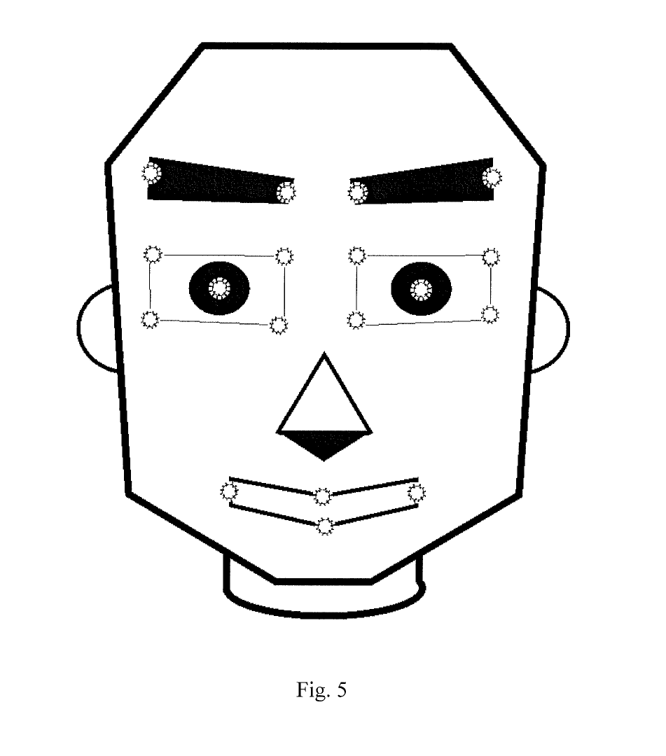

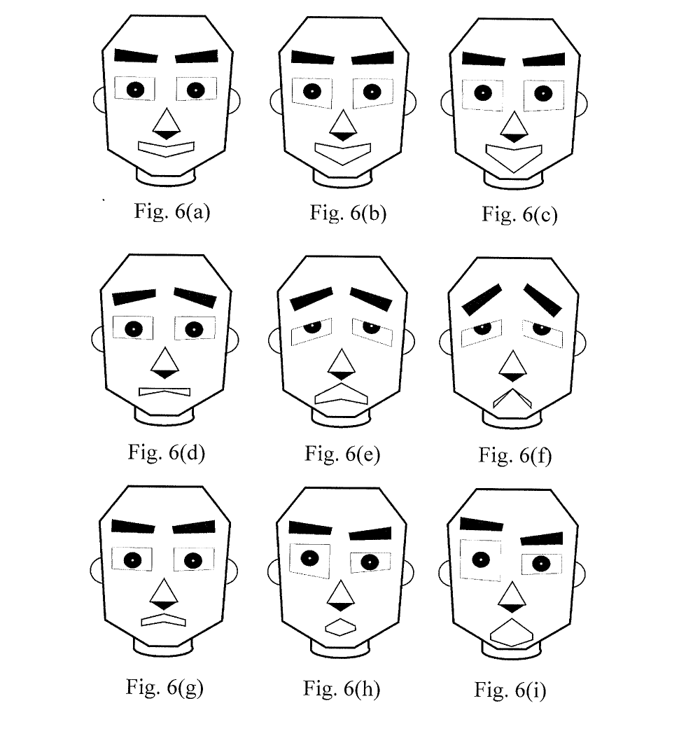

In the present invention, the character of the robot itself can be determined by setting different rules. As shown in FIGS. 6(a)˜6(i), it is a case that the robotic face expression in the robot reaction unit of the present invention is varied under different happiness and sadness output behavior weights. For example, first, an optimistic character is assigned to the robot, and the following rule table 1 is a robotic face rule table having an optimistic character. Therefore, when nobody appears in front of the robot, its output behavior is set to be completely dominated by boredom. At this time, the weight of the boring behavior is set to be 1, as shown in the third row of rule table 1. Since the emotional state for the optimistic character basically tends to be happy, when the emotional state of a user is set to be neutral, a corresponding output behavior has 70% of boredom, and 30% of happiness, as shown in the fourth row of rule table 1. When the user have over 50% of happy emotion reaction, since the robot is optimistic, the emotion of the robot is set to be a behavior output with 100% of happiness, as shown in the fifth row of rule table 1. Similarly, in this embodiment, it is designed based on the optimistic character that when the emotion of the user is anger, although the robot somewhat feels sad, it's not so bad yet. Therefore, the output behavior is set to be 50% of sadness and 50% of happiness. Moreover, when the user feels very sad, the robot should originally feel sad too, but due to its optimistic character, the robot has a behavior output with 30% of boredom in 70% of sadness.

RULE TABLE 1

| Input Emotional Strength | | | | | | |
|---|---|---|---|---|---|---|
| Conditions | | | | Output Behavior Weights | | |
| Neutral | Happiness | Anger | Sadness | Boredom | Happiness | Sadness |
| 0 | 0 | 0 | 0 | 1 | 0 | 0 |
| 1 | 0 | 0 | 0 | 0.7 | 0.3 | 0 |
| 0 | 0.5 | 0 | 0 | 0 | 1 | 0 |
| 0 | 0 | 1 | 0 | 0 | 0.5 | 0.5 |
| 0 | 0 | 0 | 1 | 0.3 | 0 | 0.7 |

As the correspondence of the above rule table 1, the following rule table 2 is a robotic face rule table which considers the robot having a pessimistic character. Similarly, the exemplary character rule can vary with everyone's subjectivity. However, it must be noted that the objective of the exemplary embodiment is mainly to describe the character of the robot can be customized by the instituted rule.

RULE TABLE 2

| Input Emotional Strength | | | | | | |
|---|---|---|---|---|---|---|
| Conditions | | | | Output Behavior Weights | | |
| Neutral | Happiness | Anger | Sadness | Boredom | Happiness | Sadness |
| 0 | 0 | 0 | 0 | 1 | 0 | 0 |
| 1 | 0 | 0 | 0 | 0.5 | 0 | 0.5 |
| 0 | 1 | 0 | 0 | 0 | 0.2 | 0.8 |
| 0 | 0 | 0.5 | 0 | 0 | 0 | 1 |
| 0 | 0 | 0 | 1 | 0.3 | 0 | 1 |

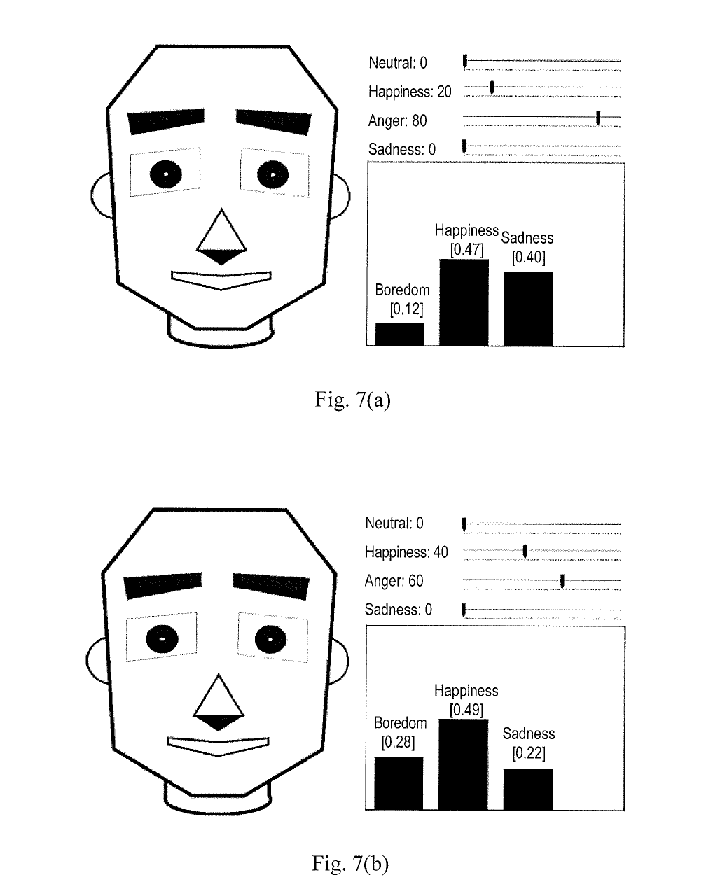

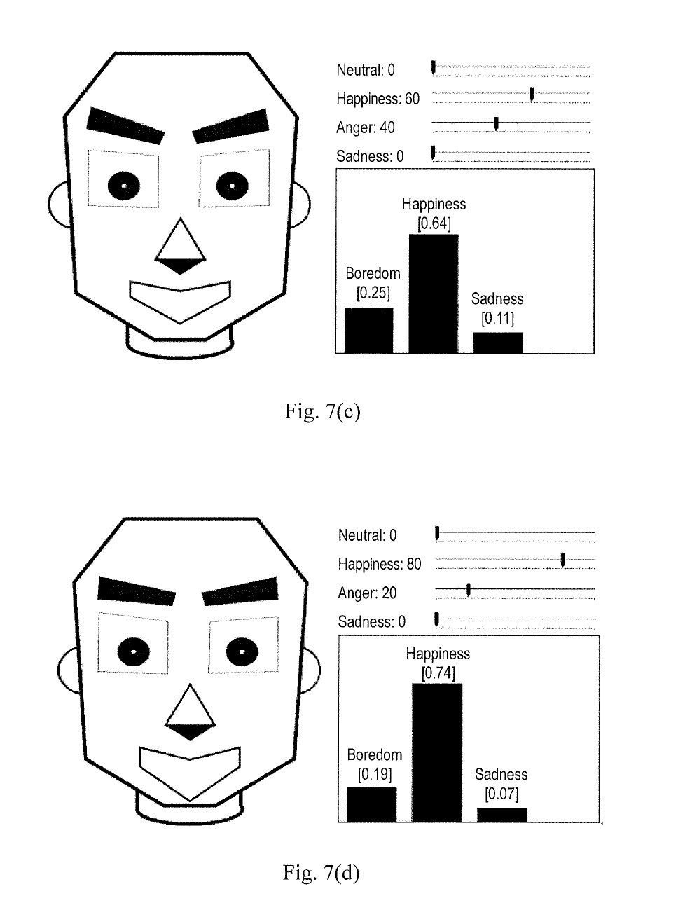

In the exemplary embodiment of the present invention, when a user simultaneously has emotional strengths of happiness and sadness as an input, the variation of the robotic face expression can be observed by a face expression simulator, as shown in FIGS. 7(a) to 7(d).

In FIG. 7(a), when the user inputs an expression with 20% of happiness and 80% of anger in strength, its output behavior weights as a result of the behavior fusion as described in previous section indicate an expression with 47% of happiness, 40% of sadness, and 12% of boredom. At this time, the robotic face shows a somewhat sad and crying expression.

In FIG. 7(b), when the user inputs an expression with 40% of happiness and 60% of anger in strength, its output behavior weights indicate an expression with 49% of happiness, 22% of sadness, and 28% of boredom. At this time, the robotic face shows a less sad expression, as compared with that in FIG. 7(a).

In FIG. 7(c), when the user inputs an expression with 60% of happiness and 40% of anger in strength, its output behavior weights indicate an expression with 64% of happiness, 11% of sadness, and 25% of boredom. At this time, the robotic face shows a little happy expression.

In FIG. 7(d), when the user inputs an expression with 80% of happiness and 20% of anger in strength, its output behavior weights indicate an expression with 74% of happiness, 7% of sadness, and 19% of boredom. At this time, the robotic face shows a very happy expression.

Through the above embodiments, it can be observed that the technology of the present invention can make a robot itself have human-like emotion and personality characteristic so that it have a complex expression behavior output during the interaction with a user and make the human-robot interactive process more nature and decent.

The above description is merely the preferred embodiments of the present invention. However, the applied scope of the present invention is not limited to this. For example, the emotion and personality characteristic outputs of the robot are not limited to the appearance of expression, and they can further be various different behaviors. Moreover, the present invention can be not only applied to a robot, but also to the human-machine interfaces of various interactive toys, computers, and personal digital assistants (PDAs), so that these devices can generate a human face graph with an anthropomorphic emotion expression, the emotion reaction of which is generated and established according to the content of the present invention. Therefore, ordinary persons skilled in the art can make various modifications and changes without departing from the principle and spirit of the present invention defined by the annotated claims.

### LIST OF REFERENCE NUMERALS

1 sensing unit
2 user emotion recognition unit
3 robot emotion generation unit
4 behavior fusion unit
5 robot reaction unit
21 CMOS image sensor
22 emotional state recognizer
23˜26 robotic emotional states
31 rule table
221 image recognizer
222˜225 emotional strengths
226 fuzzy-neuro network
FW₁˜FWₖ output behavior weights

What is claimed is:

1. A device for expressing robot autonomous emotions, comprising:
a sensing unit, obtaining sensed information;
a user emotion recognition unit, recognizing current user emotional states after receiving the information sensed from the sensing unit, and calculating user emotional strengths based on the current user emotional states;
a robot emotion generation unit, generating robot emotional states based on the user emotional strengths;
a behavior fusion unit, calculating a plurality of output behavior weights by a fuzzy-neuro network based on the user emotional strengths and a rule table for a plurality of input emotional strength conditions and a plurality of output behavior weights; and
a robot reaction unit, expressing a robot emotional behavior based on the output behavior weights and the robot emotional states.

2. The device according to claim 1, wherein the fuzzy-neuro network is an unsupervised learning neuro-network.

3. The device according to claim 1, wherein the fuzzy-neuro network is a fuzzy Kohonen clustering network (FKCN) having an at least three-layer structure and a full connection in the linkers between different layers of neurons.

4. The device according to claim 3, wherein the fuzzy-neuro network comprise: an input layer, to which a pattern to be identified are inputted; a distance layer, calculating the difference grades between the inputted pattern and a typical pattern; and a membership layer, calculating a membership grade of the inputted pattern with respect to the typical pattern, wherein the membership grade is a value between 0 and 1.

5. The device according to claim 1, wherein the sensed information comprises information obtained by at least one of a camera, a microphone, an ultrasonic device, a laser scanner, a touch sensor, a complementary metal oxide semiconductor (CMOS) image sensor, a temperature sensor and a pressure sensor.

6. The device according to claim 1, wherein the rule table contains at lease one set of user emotional strength weights and at least one set of robot behavior weights corresponding to the user emotional strength weights.

7. The device according to claim 1, wherein the robot reaction unit comprises a robotic face expression simulator for expressing a robot emotional behavior.

8. The device according to claim 7, wherein the robot reaction unit comprises an output graphical robot face, wherein the output graphical robot face expresses human face-like emotions.

9. The device according to claim 8, wherein the output graphical robot face is applicable to one of a toy, a personal digital assistant (PDA), an intelligent mobile phone, a computer and a robotic device.

10. A method for expressing robot autonomous emotions, comprising:
obtaining sensed information by a sensing unit;
recognizing current user emotional states based on the sensed information and calculating user emotional strengths based on the current user emotional states by an emotion recognition unit;
generating robot emotional states based on the user emotional strengths;
calculating a plurality of output behavior weights by a fuzzy-neuro network based on the user emotional strengths and a rule table; and
expressing a robot emotional behavior based on the output behavior weights and the robot emotional states.

11. The method according to claim 10, wherein the sensed information comprises information obtained by at least one of a camera, a microphone, an ultrasonic device, a laser scanner, a touch sensor, a complementary metal oxide semiconductor (CMOS) image sensor, a temperature sensor and a pressure sensor.

12. The method according to claim 10, wherein the fuzzy-neuro network is a fuzzy Kohonen clustering network (FKCN) having at least three-layer structure and a full connection in the linkers between different layers of neurons.

13. The method according to claim 12, wherein the fuzzy-neuro network comprises: an input layer, to which a pattern to be identified are inputted; a distance layer, calculating the difference grades between the inputted pattern and a typical pattern; and a membership layer, calculating a membership grade of the inputted pattern with respect to the typical pattern, wherein the membership grade is a value between 0 and 1.

14. The method according to claim 10, wherein the fuzzy-neuro network is an unsupervised learning neuro-network.

15. The method according to claim 10, wherein the rule table contains at lease one set of user emotional strength weights and at least one set of robot behavior weights corresponding to the user emotional strength weights.

16. The method according to claim 10, wherein the robot reaction unit comprises a robotic face expression simulator for expressing a robot emotional behavior.
